(19) United States
(12) Patent Application Publication
(10) Pub. No.: US 2026/0066565 A1
(43) Pub. Date: Mar. 5, 2026

(54) CONDUCTIVE FILM WITH IMPROVED STRUCTURES, CONNECTION ASSEMBLY AND METHOD OF MANUFACTURING THE SAME

(71) Applicant: DONGGUAN LUXSHARE TECHNOLOGIES CO., LTD, Dongguan City (CN)

(72) Inventors: Jinchuang LAN, Dongguan City (CN); Kunlin YAO, Dongguan City (CN)

(73) Assignee: DONGGUAN LUXSHARE TECHNOLOGIES CO., LTD, Dongguan City (CN)

(21) Appl. No.: 18/937,503

(22) Filed: Nov. 5, 2024

(30) Foreign Application Priority Data
Sep. 4, 2024 (CN) 202411238684.9

(51) Int. Cl. H01R 13/24; H01R 13/405; H01R 13/6471; H01R 43/24

(52) U.S. Cl. CPC H01R 13/2407; H01R 13/405; H01R 13/6471; H01R 43/24

(57) ABSTRACT

A conductive film includes a skeleton and an elastic assembly. The skeleton includes a first surface and a second surface. The elastic assembly includes an elastomer and a number of conductive elements embedded in the elastomer. The conductive elements include a first signal element, a second signal element and a number of ground elements. The first signal element and the second signal element form a differential signal pair. The ground elements are discretely surrounding the differential signal pair. Each conductive element includes a first mating surface and a second mating surface. The first mating surface is configured to abut against a first conductive component of a first mating module. The second mating surface is configured to abut against a second conductive component of a second mating module. A connection assembly having the conductive film and a method of manufacturing the conductive film are also disclosed.

### CROSS-REFERENCE TO RELATED APPLICATION

This patent application claims priority of a Chinese Patent Application No. 202411238684.9, filed on Sep. 4, 2024 and titled “CONDUCTIVE FILM, CONNECTION ASSEMBLY AND METHOD OF MANUFACTURING THE SAME”, the entire content of which is incorporated herein by reference.

### TECHNICAL FIELD

The present disclosure relates to a conductive film, a connection assembly and a method of manufacturing the conductive film, which belongs to the technical field of connectors.

### BACKGROUND

Electrical connectors in the related art usually include an insulating body and a plurality of conductive terminals. The conductive terminal is usually provided with an elastic mating arm and a mounting foot. The elastic mating arm is configured to contact a mating connector. The mounting foot is configured for being mounted to a circuit board. In order to improve the signal transmission rate, the plurality of conductive terminals usually include a first signal terminal, a second signal terminal, a first ground terminal and a second ground terminal. The first signal terminal and the second signal terminal form a differential pair.

However, as the signal transmission requirements of electrical connectors continue to increase, and the size of the electrical connector itself becomes smaller and smaller, the layout of the electrical connectors in related technologies has become increasingly difficult to meet the requirements.

Therefore, it is desirable to improve the electrical connector, a connector assembly and a method of manufacturing the electrical connector in the related art.

### SUMMARY

An object of the present disclosure is to provide a conductive film with improved structures, a connection assembly having the conductive film and a method of manufacturing the conductive film.

In order to achieve the above object, the present disclosure adopts the following technical solution: a conductive film, including: a skeleton, the skeleton including a first surface and a second surface disposed opposite to the first surface; and an elastic assembly, the elastic assembly including an elastomer and a plurality of conductive elements embedded in the elastomer; the plurality of conductive elements including a first signal element, a second signal element and a plurality of ground elements; the first signal element and the second signal element forming a differential signal pair; the plurality of ground elements being discretely surrounding the differential signal pair; wherein each conductive element includes a first mating surface exposed to the first surface along a first direction and a second mating surface exposed to the second surface along the first direction; the first mating surface is configured to abut against a first conductive component of a first mating module, and the second mating surface is configured to abut against a second conductive component of a second mating module, so that the first conductive component and the second conductive component realizes electrical connection through the conductive element.

In order to achieve the above object, the present disclosure adopts the following technical solution: a connection assembly, including: a conductive film, the conductive film including: a skeleton, the skeleton including a first surface and a second surface disposed opposite to the first surface; and an elastic assembly, the elastic assembly including an elastomer and a plurality of conductive elements embedded in the elastomer; the plurality of conductive elements including a first signal element, a second signal element and a plurality of ground elements; the first signal element and the second signal element forming a differential signal pair; the plurality of ground elements being discretely surrounding the differential signal pair; wherein each conductive element includes a first mating surface exposed to the first surface along a first direction and a second mating surface exposed to the second surface along the first direction; a first mating module, the first mating module including a plurality of first conductive components and a first ground portion; and a second mating module, the second mating module including a plurality of second conductive components and a second ground portion; wherein the first mating module and the second mating module are located on two sides of the conductive film, respectively; the first ground portion of the first mating module and the second ground portion of the second mating module are configured to be in electrical contact with the ground elements of the conductive film; the first conductive component abuts against the first mating surface of the conductive element; the second conductive component abuts against the second mating surface of the conductive element.

In order to achieve the above object, the present disclosure adopts the following technical solution: a method of manufacturing a conductive film, the conductive film including: a skeleton, the skeleton including a first surface and a second surface disposed opposite to the first surface; and an elastic assembly, the elastic assembly including an elastomer and a plurality of conductive elements embedded in the elastomer; the plurality of conductive elements including a first signal element, a second signal element and a plurality of ground elements; the first signal element and the second signal element forming a differential signal pair; the plurality of ground elements being discretely surrounding the differential signal pair; wherein each conductive element includes a first mating surface exposed to the first surface along a first direction and a second mating surface exposed to the second surface along the first direction; the first mating surface is configured to abut against a first conductive component of a first mating module, and the second mating surface is configured to abut against a second conductive component of a second mating module, so that the first conductive component and the second conductive component realizes electrical connection through the conductive element; the method including: providing the skeleton, the skeleton defining a filling space and a plurality of slots being in communication with the filling space; providing a mixture of the elastomer and the plurality of conductive elements and the mixture being in a fluid state; filling the mixture into the filling space and the plurality of slots; and heating the mixture to solidify.

Compared with the prior art, the conductive film, the connection assembly and the method of manufacturing the conductive film of the present disclosure include the elastic assembly. The elastic assembly includes the elastomer and the plurality of conductive elements embedded in the elastomer. The plurality of conductive elements include the first signal element, the second signal element and the plurality of ground elements. The first signal element and the second signal element form the differential signal pair. The plurality of ground elements are discretely surrounding the differential signal pair, thereby improving the shielding effect. Each conductive element includes the first mating surface exposed to the first surface along the first direction and the second mating surface exposed to the second surface along the first direction. The first mating surface is configured to abut against the first conductive component of the first mating module. The second mating surface is configured to abut against the second conductive component of the second mating module. When the first mating module and the second mating module are mated with the conductive film, the elastomer is elastically deformed due to being pressed to absorb the flatness error. As a result, the contact reliability between the conductive element and the first conductive component and the second conductive component is improved.

### BRIEF DESCRIPTION OF DRAWINGS

FIG. 1 is a schematic perspective view of a conductive film in accordance with an embodiment of the present disclosure;

FIG. 2 is a partial enlarged view of circled part B in FIG. 1;

FIG. 3 is a perspective view of FIG. 1 from another angle;

FIG. 4 is a top view of FIG. 1;

FIG. 5 is a bottom view of FIG. 1;

FIG. 6 is an exploded perspective view of FIG. 1;

FIG. 7 is an exploded perspective view of FIG. 6 from another angle;

FIG. 8 is a schematic cross-sectional view taken along line C-C in FIG. 4, and schematically depicts a first mating module and a second mating module;

FIG. 9 is a partial enlarged view of frame part D in FIG. 8;

FIG. 10 is a schematic view of the first mating module and the second mating module in FIG. 9 when they are in mating with the conductive film;

FIG. 11 is a schematic view of a first signal element and a second signal element in FIG. 10 when they receive a pressing force along a first direction;

FIG. 12 is a schematic view of a state of the first signal element and the second signal element before being pressed; and

FIG. 13 is a schematic view of a state of the first signal element and the second signal element in FIG. 12 after being pressed.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of”mentioned in the present disclosure includes two or more.

Hereinafter, some embodiments of the present disclosure will be described in detail with reference to the accompanying drawings. In the case of no conflict, the following embodiments and features in the embodiments can be combined with each other.

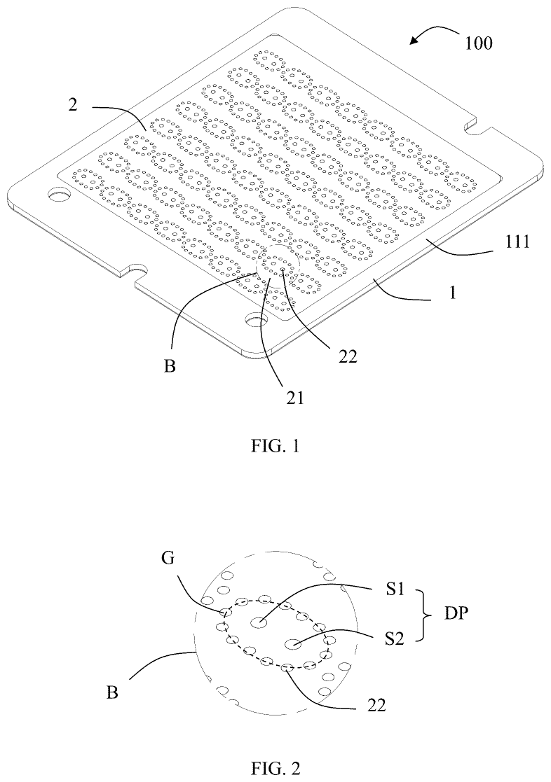

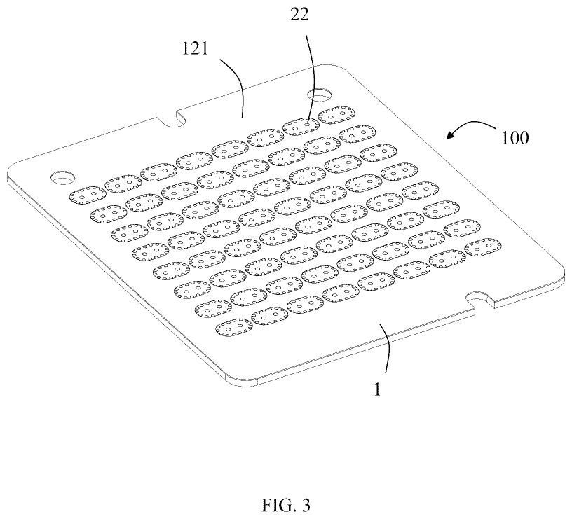

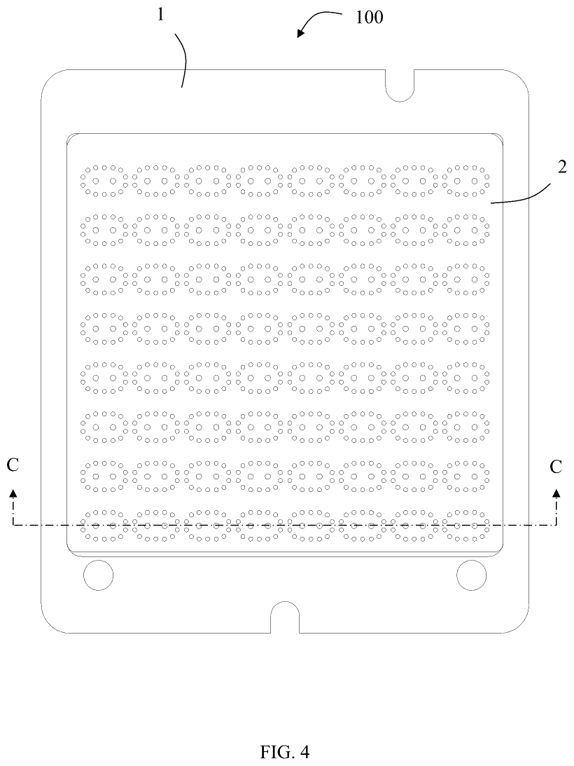

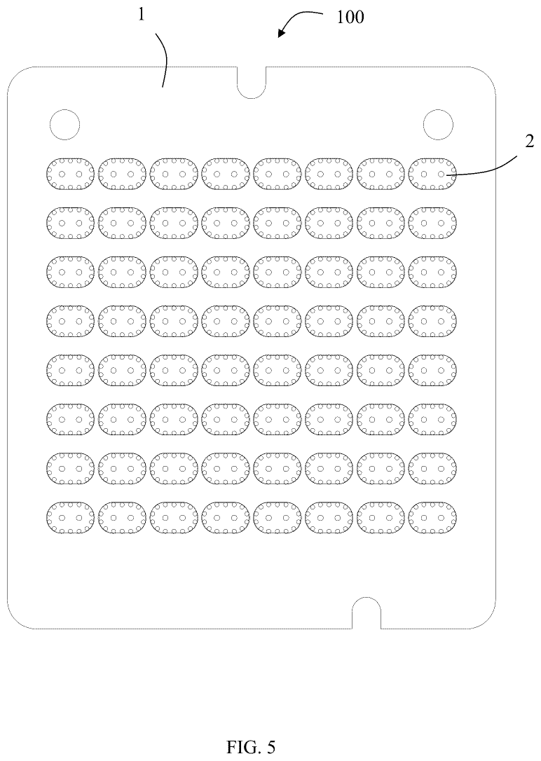

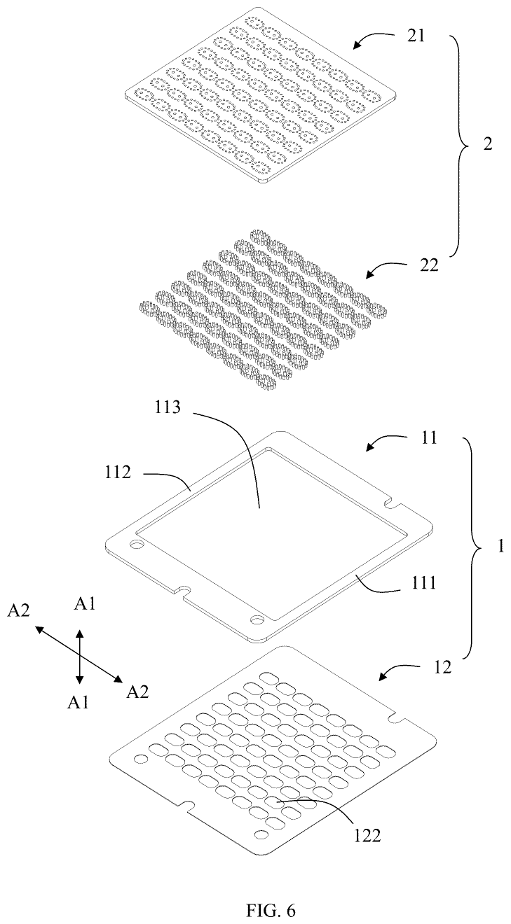

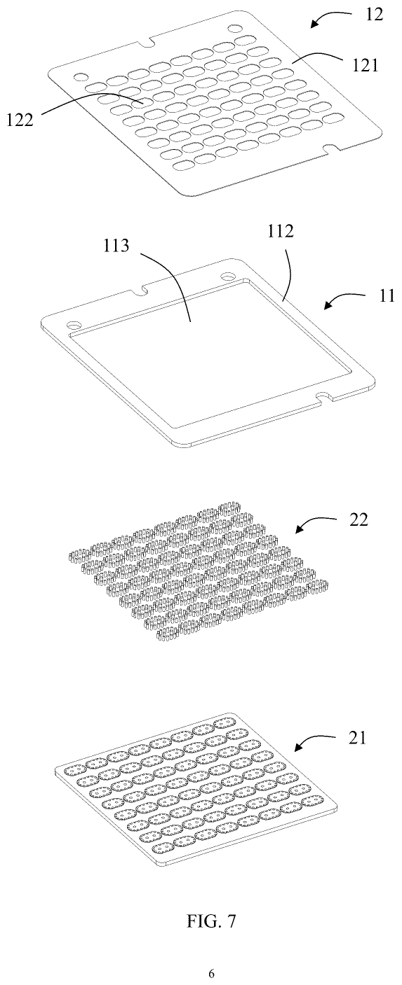

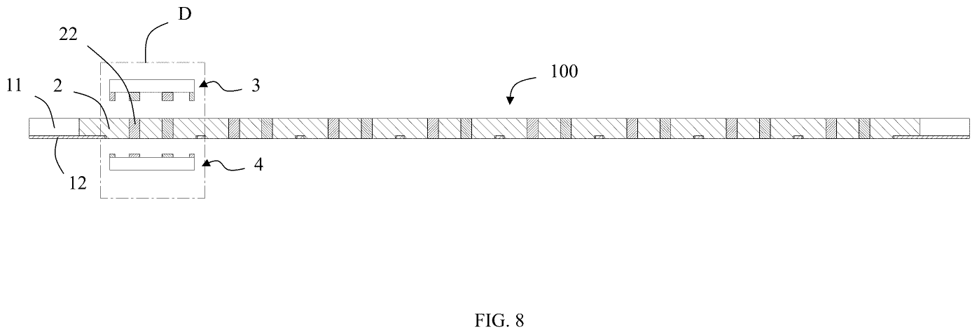

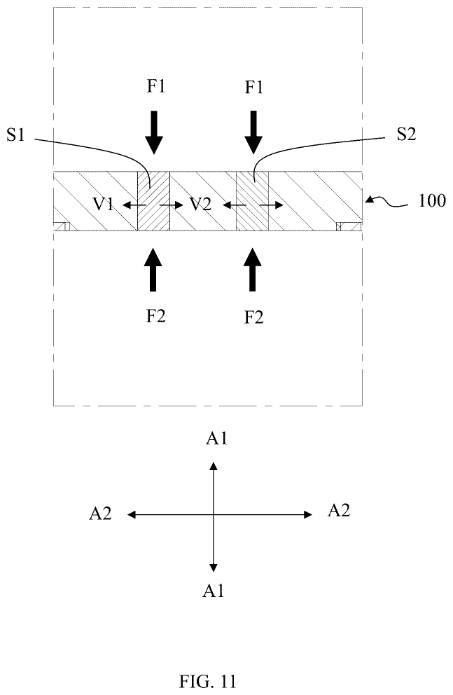

Referring to FIG. 1 to FIG. 13, the present disclosure discloses a conductive film 100 which includes a skeleton 1 and an elastic assembly 2 fixed to the skeleton 1.

In the illustrated embodiment of the present disclosure, the skeleton 1 includes a first base plate 11 and a second base plate 12 fixed on the first base plate 11. The first base plate 11 includes a first surface 111 (for example, an upper surface). The second base plate 12 includes a second surface 121 (for example, a lower surface) opposite to the first surface 111.

In the illustrated embodiment of the present disclosure, the first base plate 11 is a metal base plate (for example, a steel frame structure) to provide better structural strength. The first base plate 11 includes a surrounding frame 112 and a filling space 113 located within the surrounding frame 112. In the illustrated embodiment of the present disclosure, the filling space 113 extends through the first base plate 11 along a first direction A1-A1 (for example, a top-bottom direction). The surrounding frame 112 is beneficial to ensure the structural strength.

In the illustrated embodiment of the present disclosure, the second base plate 12 is a soft glue film. The second base plate 12 is provided with glue. The first base plate 11 and the second base plate 12 are fixed together by the glue. Of course, it is understandable to those skilled in the art that the first base plate 11 and the second base plate 12 can also be fixed together in other ways, which will not be described in the present disclosure.

The second base plate 12 defines a plurality of slots 122 extending through the second base plate 12 along the first direction A1-A1. The plurality of slots 122 are in communication with the filling space 113.

The elastic assembly 2 includes an elastomer 21 and a plurality of conductive elements 22 embedded in the elastomer 21. In an embodiment of the present disclosure, the elastomer 21 is a silicone elastomer. That is, the elastomer 21 is made of silicone, so that it has a certain elastic deformation ability.

The plurality of conductive elements 22 include a first signal element S1, a second signal element S2 and a number of ground elements G. The first signal element S1 and the second signal element S2 form a differential signal pair DP for transmitting high-frequency signals. The plurality of ground elements G are discretely surrounding the differential signal pair DP to improve the shielding effect and improve the quality of signal transmission. In other words, among the plurality of ground elements G surrounding the differential signal pair DP, a gap is formed between any two adjacent ground elements G. The elastomer 21 fills the gap and is connected as a whole, which is beneficial to improving the overall structural strength of the elastic assembly 2.

In the illustrated embodiment of the present disclosure, each conductive element 22 includes a first mating surface 221 exposed to the first surface 111 along the first direction A1-A1 and a second mating surface 222 exposed to the second surface 121 along the first direction A1-A1. The first mating surface 221 is configured to abut against a first conductive component 31 of a first mating module 3, and the second mating surface 222 is configured to abut against a second conductive component 41 of a second mating module 4, so that the first conductive component 31 and the second conductive component 41 are electrically connected through the conductive element 22. In other words, the conductive element 22 acts similarly to an adaptor function.

The elastic assembly 2 is filled in the filling space 113 and the slots 122. The elastomer 21 is fixed with the second base plate 12 through the glue.

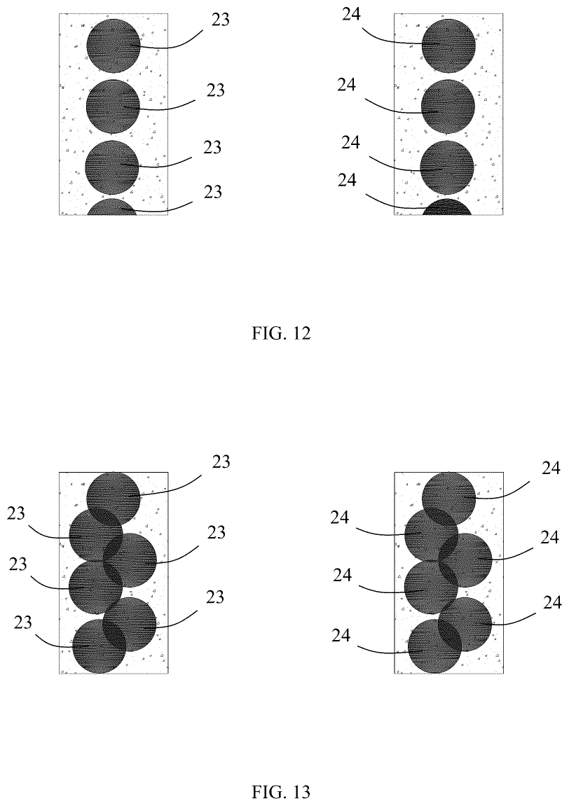

Referring to FIG. 12, in the illustrated embodiment of the present disclosure, the first signal element S1 includes a plurality of first conductors 23. The plurality of first conductors 23 are dispersed in the elastomer 21. As shown in FIG. 13, the plurality of first conductors 23 approach one another and form a first conductive path when receiving forces F1 and F2 along the first direction A1-A1.

Similarly, as shown in FIG. 12, the second signal element S2 includes a plurality of second conductors 24. The plurality of second conductors 24 are dispersed in the elastomer 21. As shown in FIG. 13, the plurality of second conductors 24 approach one another and form a second conductive path when receiving the forces F1 and F2 along the first direction A1-A1.

It is understandable to those skilled in the art that in the illustrated embodiment of the present disclosure, although the plurality of first conductors 23 are dispersed in the elastomer 21, the plurality of first conductors 23 are not uniformly dispersed in the elastomer 21. On the contrary, the plurality of first conductors 23 are gathered around the first signal element S1, thereby facilitating the formation of the first conductive path when being pressed by an external force. In addition, the plurality of first conductors 23 correspond to the position of the first conductive component 31 of the first mating module 3.

Similarly, in the illustrated embodiment of the present disclosure, although the plurality of second conductors 24 are dispersed in the elastomer 21, the plurality of second conductors 24 are not uniformly dispersed in the elastomer 21. On the contrary, the plurality of second conductors 24 are gathered around the second signal element S2, thereby facilitating the formation of the second conductive path when being pressed by an external force. In addition, the plurality of second conductors 24 correspond to the position of the second conductive component 41 of the second mating module 4.

Specifically, in the illustrated embodiment of the present disclosure, the first conductor 23 is a spherical conductor and is dispersed in the elastomer 21. The second conductor 24 is a spherical conductor dispersed in the elastomer 21. When the first conductors 23 receive the forces F1 and F2 along the first direction A1-A1, the first conductors 23 approach and contact each other along the first direction A1-A1. On the other hand, the first conductors 23 move along a second direction A2-A2 (for example, radial directions V1 and V2). The first direction A1-A1 and the second direction A2-A2 are perpendicular to each other. The change of the second conductors 24 when they are subjected to the forces F1 and F2 along the first direction A1-A1 is the same as that of the first conductors 23, and will not be described again in the present disclosure.

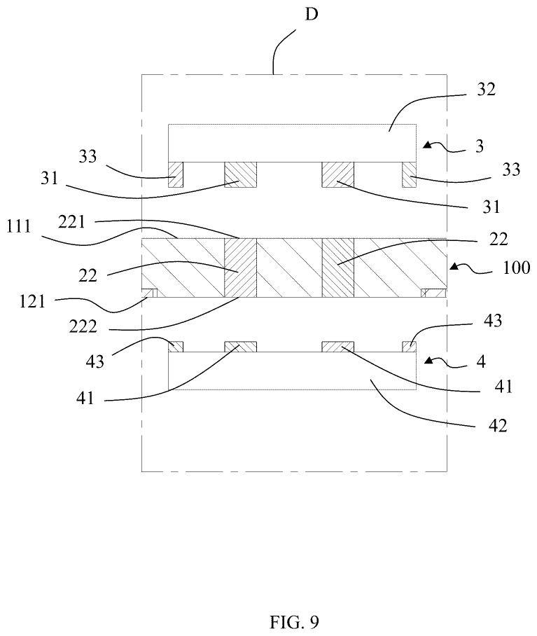

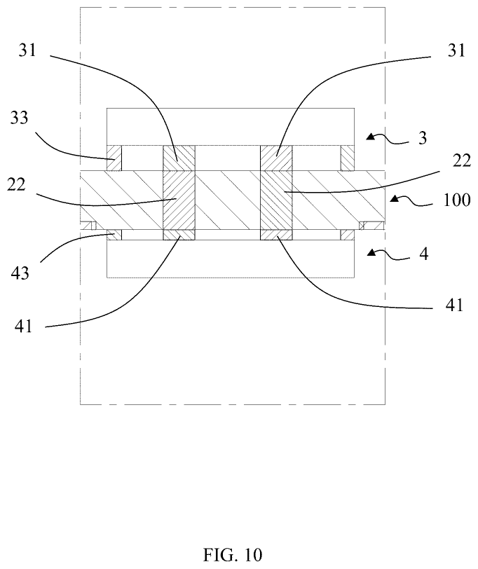

As shown in FIG. 9 and FIG. 10, the first mating module 3 includes a first insulating body 32 and a plurality of first conductive components 31 fixed to the first insulating body 32. The first mating module 3 is provided with a first ground portion 33. Preferably, the first ground portion 33 is fixed to the first insulating body 32. The relative positional relationship between the first conductive components 31 and the first ground portion 33 can be flexibly adjusted as needed. For example, a lower end surface of the first conductive component 31 is flush with a lower end surface of the first ground portion 33, or the lower end surface of the first conductive component 31 protrudes beyond the lower end surface of the first ground portion 33, or the lower end surface of the first ground portion 33 protrudes beyond the lower end surface of the first conductive component 31. Of course, it is understandable to those skilled in the art that the first mating module 3 can be an electrical connector or a circuit board.

Similarly, the second mating module 4 includes a second insulating body 42 and a plurality of second conductive components 41 fixed to the second insulating body 42. The second mating module 4 is provided with a second ground portion 43. Preferably, the second ground portion 43 is fixed to the second insulating body 42. The relative positional relationship between the second conductive components 41 and the second ground portion 43 can be flexibly adjusted as needed. For example, an upper end surface of the second conductive component 41 is flush with an upper end surface of the second ground portion 43, or the upper end surface of the second conductive component 41 protrudes beyond the upper end surface of the second ground portion 43, or the upper end surface of the second ground portion 43 protrudes beyond the upper end surface of the second conductive component 41. Of course, it is understandable t those skilled in the art that the second mating module 4 can be an electrical connector or a circuit board.

The first mating module 3 and the second mating module 4 are located on two sides (for example, upper and lower sides) of the conductive film 100, respectively. The first ground portion 33 of the first mating module 3 and the second ground portion 43 of the second mating module 4 are configured to be in electrical contact with the ground elements G of the conductive film 100. The first conductive component 31 abuts against the first mating surface 221 of the conductive element 22. The second conductive component 41 abuts against the second mating surface 222 of the conductive element 22. Finally, the first conductive component 31 and the second conductive component 41 are electrically connected with each other through the conductive element 22. Of course, it is understandable to those skilled in the art that during the process of the first mating module 3 and the second mating module 4 coming into abut against the conductive film 100, the elastomer 21 will receive external forces and undergo compression deformation, which is beneficial to absorbing the flatness error of the contact piece.

The present disclosure also discloses a method for manufacturing the aforementioned conductive film 100, includes:
providing the skeleton 1, the skeleton 1 defining the filling space 113 and the plurality of slots 122 in communication with the filling space 113;
providing a mixture of the elastomer 21 and the plurality of conductive elements 22, and the mixture is in a fluid state;
filling the mixture into the filling space 113 and the slots 122; and
heating the mixture to solidify.

Specifically, in the illustrated embodiment of the present disclosure, the skeleton 1 includes the first base plate 11 and the second base plate 12. The first base plate 11 is cut into the required shape and size using an etching or laser cutting process according to the designed size in advance. A laser cutting process is used to remove a portion of material to form the slots 122. The slots 122 are at certain distances from the first signal element S1 and the second signal element S2, and will not constrain the compression deformation of the first signal element S1 and the second signal element S2 in the first direction A1-A1.

The second base plate 12 is provided with glue (for example, solid glue) with specific bonding ability to bond with the first base plate 11 so as to form the skeleton 1. The second base plate 12 is also bonded to the elastomer 21 through the glue to fix the elastomer 21.

The material of the elastomer 21 is a medium elastic material, which is used to absorb the flatness error of the contact piece. When the elastomer 21 is pressed by an external force, it will drive the conductive elements 22 to move together. The elastomer 21 has a shape and size corresponding to the slots 122 and matches the slots 122. The elastomer 21 is first mixed with the conductive elements 22 in a liquid form. Then, after a certain high temperature, the elastomer 21 changes from a liquid state to a solid state, and the conductive elements 22 are fixed. Preferably, the first mating surface 221 and the second mating surface 222 of the conductive element 22 are flush with the first surface 111 and the second surface 121, respectively. Of course, it is understandable to those skilled in the art that in other embodiments of the present disclosure, the first mating surface 221 of the conductive element 22 may also be slightly lower than the first surface 111, and the second mating surface 222 of the conductive element 22 may be slightly higher than the second surface 121. In other words, the conductive element 22 is located between the first surface 111 and the second surface 121. When the conductive film 100 is mated with the first mating module 3 and the second mating module 4, the elastomer 21 is pressed by an external force and compressed. At this time, the first mating surface 221 and the second mating surface 222 of the conductive element 22 can also be in contact with the first conductive component 31 of the first mating module 3 and the second conductive component 41 of the second mating module 4, respectively, to achieve electrical conduction.

In one embodiment of the present disclosure, the conductive element 22 is a special spherical alloy ion conductor.

In some embodiments of the present disclosure, the material of the elastomer 21 has a dielectric constant DK, where 1.8≤DK≤3.2. The elastomer 21 can provide the conductive element 22 with elastic force for continuous operation.

In some embodiments, the conductive element 22 is made of a mixture of a plurality of tiny metal ions and some special solid glue, wherein the proportion of metal ions in the conductive element 22 is greater than or equal to 70%.

It is understandable to those skilled in the art that there may be a certain flatness error between the lower end surface of the first ground portion 33 of the first mating module 3 and the lower end surface of the first conductive component 31. Therefore, there may be a risk of signal transmission being interrupted between the lower end surface of the first conductive component 31 and the first mating surface 221 of the conductive element 22. Similarly, there may also be a certain flatness error between the upper end surface of the second ground portion 43 of the second mating module 4 and the upper end surface of the second conductive component 41. Therefore, there may be a risk of signal transmission interruption between the upper end surface of the second conductive component 41 and the second mating surface 222 of the conductive element 22. Therefore, there is a need for a device that can both transmit signals and absorb high unevenness errors at the signal contact points. The conductive film 100 of the present disclosure can just meet this requirement.

Compared with the prior art, the conductive film 100, the connection assembly and the method of manufacturing the conductive film 100 disclosed in the present disclosure include the elastic assembly 2. The elastic assembly 2 includes the elastomer 21 and the plurality of conductive elements 22 embedded in the elastomer 21. The plurality of conductive elements 22 include the first signal element S1, the second signal element S2 and the plurality of ground elements G. The first signal element S1 and the second signal element S2 form the differential signal pair DP. The plurality of ground elements G are discretely surrounding the differential signal pair DP, thereby improving the shielding effect. Each conductive element 22 includes the first mating surface 221 exposed to the first surface 111 along the first direction A1-A1 and the second mating surface 222 exposed to the second surface 121 along the first direction A1-A1. The first mating surface 221 is configured to abut against the first conductive component 31 of the first mating module 3. The second mating surface 222 is configured to abut against the second conductive component 41 of the second mating module 4. When the first mating module 3 and the second mating module 4 abut against the conductive film 100, the elastomer 21 is elastically deformed due to being pressed to absorb the flatness error, thereby improving the contact reliability between the conductive element 22 and the first conductive component 31 and the second conductive component 41.

In addition, compared with the prior art, the installation size of the conductive film 100 disclosed in the present disclosure is smaller, which greatly saves the space size of the high-frequency electrical connection structure. The size of the conductive film 100 disclosed in the present disclosure is smaller along the first direction A1-A1, which greatly reduces the loss on the high-frequency signal transmission path. The conductive film 100 disclosed in the present disclosure has a wider range of application scenarios, can be applied to a variety of high-frequency signal transmission application scenarios, and is suitable for high-density layout connection structures.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A conductive film, comprising:
a skeleton, the skeleton comprising a first surface and a second surface disposed opposite to the first surface; and
an elastic assembly, the elastic assembly comprising an elastomer and a plurality of conductive elements embedded in the elastomer; the plurality of conductive elements comprising a first signal element, a second signal element and a plurality of ground elements; the first signal element and the second signal element forming a differential signal pair; the plurality of ground elements being discretely surrounding the differential signal pair;
wherein each conductive element comprises a first mating surface exposed to the first surface along a first direction and a second mating surface exposed to the second surface along the first direction; the first mating surface is configured to abut against a first conductive component of a first mating module, and the second mating surface is configured to abut against a second conductive component of a second mating module, so that the first conductive component and the second conductive component realizes electrical connection through the conductive element.

2. The conductive film according to claim 1, wherein the first signal element comprises a plurality of first conductors which are dispersed in the elastomer; the plurality of first conductors approach one another and form a first conductive path when receiving a force along the first direction;
the second signal element comprises a plurality of second conductors which are dispersed in the elastomer; the plurality of second conductors approach one another and form a second conductive path when receiving another force along the first direction.

3. The conductive film according to claim 1, wherein the skeleton comprises a first base plate and a second base plate fixed on the first base plate; the first surface is provided on the first base plate; the second surface is provided on the second base plate.

4. The conductive film according to claim 3, wherein the first base plate is made of metal;
the second base plate is a soft glue film provided with glue, and the first base plate and the second base plate are fixed together through the glue.

5. The conductive film according to claim 4, wherein the first base plate defines a filling space extending therethrough along the first direction; the second base plate defines a plurality of slots extending therethrough along the first direction; the plurality of slots being in communication with the filling space; the elastic assembly is filled in the filling space and the plurality of slots; the elastomer is fixed with the second base plate through the glue.

6. The conductive film according to claim 5, wherein the first base plate comprises a surrounding frame in which the filling space is located.

7. The conductive film according to claim 3, wherein the first mating surface of the conductive element is flush with the first surface of the first base plate, or the first mating surface of the conductive element is lower than the first surface of the first base plate; and/or
the second mating surface of the conductive element is flush with the second surface of the second base plate, or the second mating surface of the conductive element is higher than the second surface of the second base plate.

8. The conductive film according to claim 1, wherein the elastomer is a silicone elastomer.

9. The conductive film according to claim 1, wherein among the plurality of ground elements surrounding the differential signal pair, a gap is formed between any two adjacent ground elements, and the elastomer fills the gap and is connected as a whole.

10. The conductive film according to claim 1, wherein the first signal element comprises a plurality of first conductors which are dispersed in the elastomer but gathered around the first signal element;
the second signal element comprises a plurality of second conductors which are dispersed in the elastomer but gathered around the second signal element.

11. A connection assembly, comprising:
a conductive film, the conductive film comprising:
a skeleton, the skeleton comprising a first surface and a second surface disposed opposite to the first surface; and
an elastic assembly, the elastic assembly comprising an elastomer and a plurality of conductive elements embedded in the elastomer; the plurality of conductive elements comprising a first signal element, a second signal element and a plurality of ground elements; the first signal element and the second signal element forming a differential signal pair; the plurality of ground elements being discretely surrounding the differential signal pair;
wherein each conductive element comprises a first mating surface exposed to the first surface along a first direction and a second mating surface exposed to the second surface along the first direction;
a first mating module, the first mating module comprising a plurality of first conductive components and a first ground portion; and
a second mating module, the second mating module comprising a plurality of second conductive components and a second ground portion;
wherein the first mating module and the second mating module are located on two sides of the conductive film, respectively; the first ground portion of the first mating module and the second ground portion of the second mating module are configured to be in electrical contact with the ground elements of the conductive film; the first conductive component abuts against the first mating surface of the conductive element; the second conductive component abuts against the second mating surface of the conductive element.

12. The connection assembly according to claim 11, wherein the first signal element comprises a plurality of first conductors which are dispersed in the elastomer; the plurality of first conductors approach one another and form a first conductive path when receiving a force along the first direction;
the second signal element comprises a plurality of second conductors which are dispersed in the elastomer; the plurality of second conductors approach one another and form a second conductive path when receiving another force along the first direction.

13. The connection assembly according to claim 11, wherein the skeleton comprises a first base plate and a second base plate fixed on the first base plate; the first surface is provided on the first base plate; the second surface is provided on the second base plate.

14. The connection assembly according to claim 13, wherein the first base plate is made of metal; the second base plate is a soft film provided with glue, and the first base plate and the second base plate are fixed together through the glue.

15. The connection assembly according to claim 14, wherein the first base plate defines a filling space extending therethrough along the first direction; the second base plate defines a plurality of slots extending therethrough along the first direction; the plurality of slots being in communication with the filling space; the elastic assembly is filled in the filling space and the plurality of slots; the elastomer is fixed with the second base plate through the glue.

16. The connection assembly according to claim 11, wherein the elastomer is a silicone elastomer.

17. The connection assembly according to claim 11, wherein among the plurality of ground elements surrounding the differential signal pair, a gap is formed between any two adjacent ground elements, and the elastomer fills the gap and is connected as a whole.

18. The connection assembly according to claim 11, wherein the first signal element comprises a plurality of first conductors which are dispersed in the elastomer but gathered around the first signal element;
the second signal element comprises a plurality of second conductors which are dispersed in the elastomer but gathered around the second signal element.

19. A method of manufacturing a conductive film, the conductive film comprising:
a skeleton, the skeleton comprising a first surface and a second surface disposed opposite to the first surface; and
an elastic assembly, the elastic assembly comprising an elastomer and a plurality of conductive elements embedded in the elastomer; the plurality of conductive elements comprising a first signal element, a second signal element and a plurality of ground elements; the first signal element and the second signal element forming a differential signal pair; the plurality of ground elements being discretely surrounding the differential signal pair;
wherein each conductive element comprises a first mating surface exposed to the first surface along a first direction and a second mating surface exposed to the second surface along the first direction; the first mating surface is configured to abut against a first conductive component of a first mating module, and the second mating surface is configured to abut against a second conductive component of a second mating module, so that the first conductive component and the second conductive component realizes electrical connection through the conductive element;
the method comprising:
providing the skeleton, the skeleton defining a filling space and a plurality of slots being in communication with the filling space;
providing a mixture of the elastomer and the plurality of conductive elements and the mixture being in a fluid state;
filling the mixture into the filling space and the plurality of slots; and
heating the mixture to solidify.

20. The method of manufacturing the conductive film according to claim 19, wherein the plurality of conductive elements comprise a first signal element and a second signal element;
the first signal element comprises a plurality of first conductors, and each first conductor is a spherical conductor dispersed in the elastomer;
the second signal element comprises a plurality of second conductors, and each second conductor is a spherical conductor dispersed in the elastomer.
